(19) United States
(12) Patent Application Publication
(10) Pub. No.: US 2025/0203440 A1
(43) Pub. Date: Jun. 19, 2025

(54) METHOD AND APPARATUS FOR NOTIFYING A PUBLIC SAFETY OFFICER OF A PUBLIC WORKS PROJECT

(71) Applicant: MOTOROLA SOLUTIONS, INC., CHICAGO, IL (US)

(72) Inventors: DAVID H MCCLINTOCK, BOYNTON BEACH, FL (US); MOHAMMED A HOSSAIN, SUNRISE, FL (US); ALEKHYA GOLLAMUDI, DAVIE, FL (US); GIORGI BIT-BABIK, PLANTATION, FL (US)

(21) Appl. No.: 18/541,115

(22) Filed: Dec. 15, 2023

(51) Int. Cl. H04W 28/02; H04W 4/02; H04W 4/021; H04W 4/12

(52) U.S. Cl. CPC H04W 28/0226; H04W 4/021; H04W 4/023; H04W 4/12

(57) ABSTRACT

A method and apparatus for notifying a public safety officer of public works projects is provided herein. During operation each public safety officer will have location data associated with the officer maintained at a public safety database. The location data comprises those locations most often frequented by the officer during their daily activities (e.g., while on the job). A public works database will be accessed by a server to determine locations of any active or future public works projects. An officer will only be notified of those public works projects when locations affected by the public works projects are nearby those locations most often frequented by the officer.

### BACKGROUND OF THE INVENTION

In larger cities, there exist dozens of planned and active public works projects. These projects can negatively affect routes used by public safety officers during their daily activities. Because of this, oftentimes messages are sent to public safety officers notifying them of every public works project within the city. Simply notifying every public safety officer within a large city of every planned or active public works project will result in information overload. In order to reduce information overload, it would be beneficial if each public safety officer would only receive a notification of public works projects when they affect the public safety officer's daily activities.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates a general operating environment.

FIG. 2 illustrates a general operating environment with a more-detailed view of the server of FIG. 1.

FIG. 3 is an illustration of a map showing a route heavily traveled by a first police officer.

FIG. 4 is an illustration of a map showing a route heavily traveled by a second police officer.

FIG. 5 is an illustration of a map showing a route heavily traveled by a third police officer.

FIG. 6 is an illustration of a map showing a location of a planned public works project.

FIG. 7 illustrates a general operating environment with a more-detailed view of the server of FIG. 1 with the addition of a public safety dispatch center.

FIG. 8 is a flow chart showing operation of the server of FIG. 2.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above-mentioned need, a method and apparatus for notifying a public safety officer of public works projects is provided herein. During operation each public safety officer will have location data associated with the officer maintained at a public safety database. The location data comprises those locations most often frequented by the officer during their daily activities (e.g., while on the job). A public works database will be accessed by a server to determine locations of any active or future public works projects. An officer will only be notified of those public works projects when locations affected by the public works projects are nearby those locations most often frequented by the officer.

Consider the following example: Officer Fred and Officer Jane both patrol various areas of a city while on duty. Officer Fred's patrol is on the northern part of the city, while Officer Jane's patrol is on the southern part of the city. During Fred's patrol, he often travels over a particular bridge, while Jane does not. If a planned or active public works project affects the particular bridge, Fred will be notified of the public works project, while Jane will not be notified. The notification that Fred receives may comprise an email, text message, or any other electronically delivered message indicating that public works will be working on the bridge that Fred frequently travels over. As is evident, because each public safety officer will only receive messages that notify them of public works projects that potentially affect them, the amount of messaging an officer receives is greatly reduced.

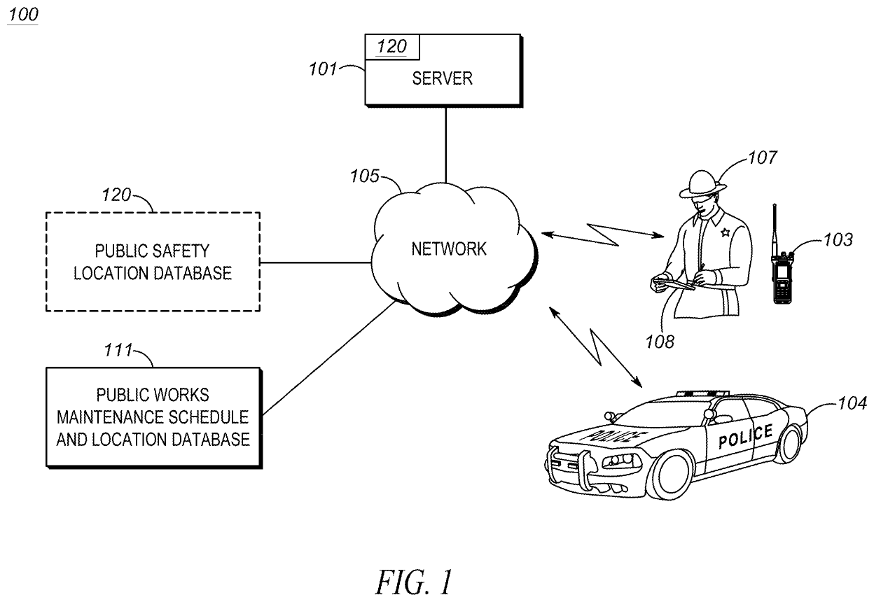

FIG. 1 illustrates a general operating environment 100 for the present invention. As shown, environment 100 is equipped with public works database 111 that comprises information on public works maintenance/construction projects taking place within a geographic area (e.g., a county, city, suburb, . . . , etc.). Such information comprises a location of a planned or active public works project and the time periods when the public works project will take place. For example, public works database 111 may comprise an entry: “Randall Road Bridge Work-Oct. 21, 2024 through Oct. 31, 2024-3200 block of Randall Road”. In the following description, an area “affected” by a public works project comprises an area within a predetermined distance (e.g., 100 meters) from the public works project. Public works database 111 is preferably populated by public-works personnel via manual entry of data, however, in alternative embodiments of the present invention public works database 111 may be populated in other ways. As shown, public works database 111 connects to server 101 via network 105.

Public safety database 120 is preferably located within server 101, however, in an alternative embodiment of the present invention, public safety database 120 is external to server 101 and accessed by server 101 via network 105. Public safety database 120 comprises entries for public safety officers along with an identification of an area most frequented by the public safety officer. Areas most frequented by an officer may comprise a “heat map” or “beat map” associated with each officer. The heat map/beat map comprises a map of geographic area with routes or locations each officer most often frequents or travels. Thus, database 120 preferably comprises a heat map and/or beat map that is associated with each officer within database 120.

Server 101 is configured to provide notifications to public safety officers about public works projects that may affect the public safety officer. This is accomplished by notifying the public safety officer when an area they frequent is nearby (e.g., 100 meters) an area affected by a public works project. (An area “affected” by a public works project comprises an area within a predetermined distance (e.g., 100 meters) from the public works project). So, for example, notifications will be sent to all officers when an area they frequent is within a predetermined distance from an area affected by a public works project.

In one embodiment of the present invention, server 101 comprises a modified Avigilon™ Control Center (ACC). Server 101 accesses public safety database 120 along with public works database 111 and determines if any officer frequents a location that is nearby an area affected by a public works project. If so, server 101 will send a notification to the officer indicating that an area the officer frequents may be affected by a public works project.

Network 105 preferably comprises a network utilized for transmitting data between entities shown in FIG. 1. Networks such as the Institute of Electrical and Electronics Engineers (IEEE) Wi-Fi 802.11 network, Long Term Evolution (LTE)/4G network, 5G network, Universal Mobile Telecommunications System (UMTS) network, or peer-to-peer (P2P) network, for example, may be utilized as networks. Alternatively, short-range networks such as Bluetooth, Zigbee, or near field communication (NFC) networks may be employed. Network 105 may utilize wireless communication in one or more bands, such as the 800-900 MHz range, 1.8-1.9 GHz range, 2.3-2.4 GHz range, 60 GHz range, and others, including infrared (IR) communications. Example communication networks 105 may comprise local area networks (LANs), wide area networks (WANs), a packet data networks (e.g., the Internet), mobile telephone networks (e.g., cellular networks), wireless data networks, or any other network.

In one embodiment of the present invention, server 101 (or another entity not shown in FIG. 1) periodically locates each public safety officer within public safety database 120 and updates public safety database 120 with the officer's location. This is preferably accomplished via server 101 (or the other entity) periodically receiving a location of a device associated with the public safety officer. More specifically, a smart device (such as police radio 103) will be assigned to an officer. The smart device is preferably equipped with a GPS receiver in order to obtain its current location and may periodically (e.g., once per minute) provide its current location to server 101 through network 105. Thus, the location of smart device 103 serves a proxy for the location of officer 107. In an alternate embodiment of the present invention, patrol car 104 may be equipped with a GPS receiver and the patrol car's location may serve as a proxy for the location of officer 107. As shown, patrol car 104, police radio 103, and public works database 111 are connected to server 101 through network 105 via network 105. Over a period of time, server 101 will be able to create a heat map of places most frequented by a police officer (e.g., places where the officer was located more than a predetermined number of times per time period, for example, more than 10 times per week). The heat map is stored in database 120.

In yet a further alternate embodiment of the present invention, public safety database 120 may be populated with a geographic area of an officer's “beat”. In law enforcement, a “beat” refers to a specific area or geographical territory to which a patrol officer is assigned. The concept of a beat is important in policing as it allows for a more efficient distribution of police resources and helps to ensure that police presence is consistent in certain areas. The areas frequented by each police officer may simply be the police officer's beat. In the alternate embodiment of the present invention, each officer's beat may be utilized as the geographic area frequented by the officer and stored in database 120.

As discussed above, server 101 may only notify officer 107 of any public works project that affects an area nearby an area frequented by officer 107. This is accomplished by using the locations of the public works projects maintained in public works database 111 with the geographic areas frequented by officer 107 to determine if there is any area frequented by the officer that is nearby an area affected by a public works project. Notification may be made via text message, instant message, email, or any other electronic notification means. With this in mind, in FIG. 1, officer 107 is in possession of a smart device 108 (e.g., a smart phone, smart tablet, . . . , etc.) that is in communication with server 101 (via network 105). While in communication with server 101, smart device 108 may be provided with the notification via network 105. In an alternative embodiment of the present invention, radio 103 may serve as a device which receives the notifications.

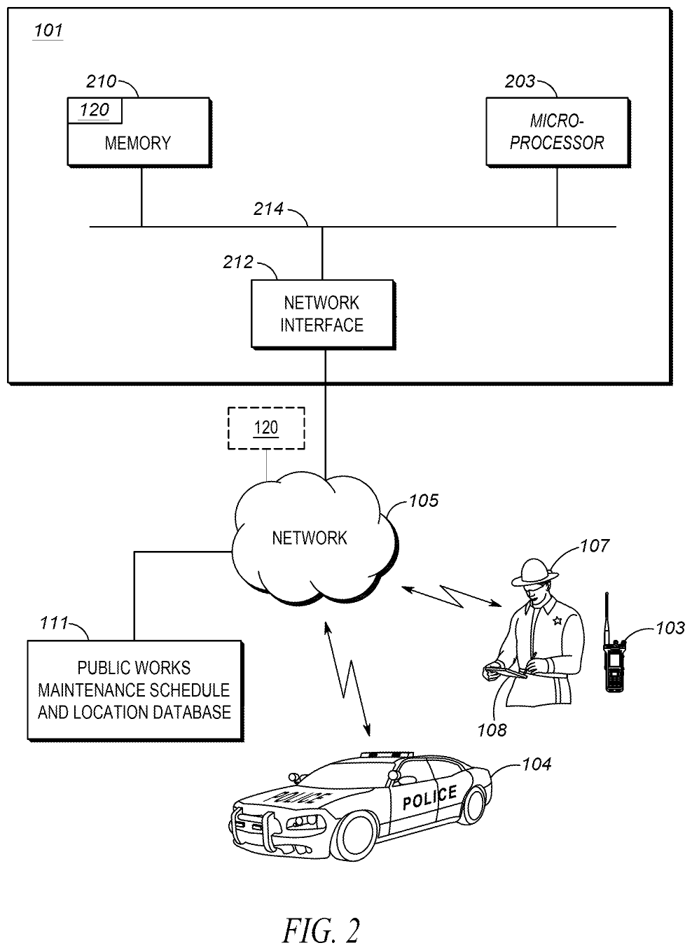

FIG. 2 illustrates a general operating environment with a more-detailed view of server 101. Server 101 may include various components connected by bus 214. Server 101 may include a hardware processor (logic circuitry) 203 such as one or more central processing units (CPUs) or other processing circuitry able to provide any of the functionality described herein when running instructions (e.g., a core of the virtualized processors, a microprocessor, a digital signal processor, a microcontroller, . . . , etc.). Processor 203 may be connected to memory 210 that may include a non-transitory machine-readable medium on which is stored one or more sets of instructions executed by processor 203. Memory 210 may include one or more of static or dynamic storage, or removable or non-removable storage, for example. A machine-readable medium may include any medium that is capable of storing, encoding, or carrying instructions for execution by processor 203, such as solid-state memories, magnetic media, and optical media. Machine-readable mediums may include, for example, Electrically Programmable Read-Only Memory (EPROM), Random Access Memory (RAM), or flash memory.

The instructions stored in memory 210 enable server 101 to operate in any manner thus programmed, such as the functionality described specifically herein, when processor 203 executes the instructions. The machine-readable medium may be stored as a single medium or in multiple media, in a centralized or distributed manner. In some embodiments, instructions may further be transmitted or received over a communications network 105 via a network interface 212 utilizing any one of a number of transfer protocols (e.g., frame relay, internet protocol (IP), transmission control protocol (TCP), user datagram protocol (UDP), hypertext transfer protocol (HTTP), etc.). A portion of memory 210 may also serve as public safety database 120.

Network interface 212 enables logic circuitry 203 to communicate data and send/receive information with other devices (e.g., device 103, automobile 104, device 108, public safety database 120 if located outside of server 101, and public works database 111) through network 105 via wired or wireless communication. Network interface 212 may include electronic components such as a transceiver that enables serial or parallel communication. The wireless connections may use one or more protocols, including Institute of Electrical and Electronics Engineers (IEEE) Wi-Fi 802.11, Long Term Evolution (LTE)/4G, 5G, Universal Mobile Telecommunications System (UMTS), or peer-to-peer (P2P), for example, or short-range protocols such as Bluetooth, Zigbee, or near field communication (NFC). Wireless communication may occur in one or more bands, such as the 800-900 MHz range, 1.8-1.9 GHZ range, 2.3-2.4 GHz range, 60 GHz range, and others, including infrared (IR) communications. Example communication networks to which server 101 may be connected via network interface 212 may include a local area network (LAN), a wide area network (WAN), a packet data network (e.g., the Internet), mobile telephone networks (e.g., cellular networks), and wireless data networks, or any other network.

As discussed above, in one embodiment of the present invention logic circuitry 203 determines those areas most frequented by a public safety officer by periodically locating the public safety officer, and maintaining location information within public safety database 120 as a “heat map”. It should be noted that public safety database 120 may be populated and maintained via other entities and located external to server 101. For example, public safety database 120 may be populated and maintained at a public safety dispatch center.

A “heat map” for an officer comprises a digital map that is shaded differently based on how “active” an officer is within the area (i.e., how often an officer is determined to be within any particular part of the geographic area). A heat map for a particular officer comprises a geographic map identifying “more active” and “less active” areas. A more “active” area for a particular officer comprises an area where the officer is detected more often over a period of time than a “less active” area. For example, a “more active” area for an officer may comprise a road that the officer is detected on at least once per day. “More active” areas for each officer may comprise any number of times the officer was detected within a geographic area per unit time (e.g., once per day, twice per day, 10 times per month, . . . , etc.). Public safety database 120 may comprise information on only those “more active” geographic areas associated with an officer, or alternatively may comprise the digital heat map.

When using a heat map to determine where an officer most frequents, logic circuitry 203 identifies more active areas on the map as an indication to where the officer most frequents. When using a beat map to determine where an officer most frequents, logic circuitry 203 uses an area of the officer's beat to determine where the officer most frequents.

Logic circuitry will access public safety database 120 to determine areas most frequented by each officer, and then access public works database 111 to determine if an area most frequented by any officer is nearby (e.g., within 100 meters from) an area affected by the public works project. If so, logic circuitry 203 will then create a message notifying the officer of this fact and transmit the message to the officer via interface 212 by sending the message to any device used by the officer (e.g., device 108).

With the above in mind, FIG. 2 shows server 101 comprising network interface 212 coupled to public works database 111 and public safety database 120. Logic circuitry 203 is provided and coupled to the network interface. Logic circuitry 203 is configured to retrieve from public safety database 120, areas frequented by a public safety officer, retrieve from public works database 111, locations of public works projects, determine if areas frequented by the public safety officer are nearby areas affected by public works projects, and electronically transmit, via network interface 212, a notification to the public safety officer when areas frequented by the public safety officer are nearby any areas affected by at least one public works project, wherein the notification indicates locations of the public works projects that are nearby areas frequented by the public safety officer.

As is evident, network interface 212 comprises a cross-agency network interface, with the public safety database being maintained by a public safety agency, and the public works database being maintained by a public works agency.

Logic circuitry 203 determines that an area is affected by the public works project when the public works project is within a predetermined distance from the area.

As discussed above, logic circuitry 203 can determine areas most frequented by a public safety officer by creating a heat map for the public safety officer. This is preferably accomplished by logic circuitry 203 determining a plurality locations of the public safety officer over a period of time. Logic circuitry 203 can then determine the areas most frequented by the public safety officer from the plurality locations of the public safety officer over the period of time and store the areas most frequented by the public safety officer in the public safety database as a heat map, or any other form.

In an alternate embodiment of the present invention the areas most frequented by the public safety officer comprise a beat map, and the beat map is stored in public safety database 120.

Consider the example of Officer Fred and Officer Jane, given above. In this example, logic circuitry 203 would be configured to retrieve from the public safety database, areas frequented by Officer Fred and Officer Jane. Logic circuitry 203 will also be configured to retrieve from the public works database, locations of public works projects and determine that areas frequented by Officer Fred are nearby areas affected by a public works project and determine that areas frequented by Officer Jane are not nearby areas affected by a public works project. Logic circuitry 203 will then only electronically transmit, via the network interface, a notification to Officer Fred based on the determination that areas frequented by Officer Fred are nearby areas affected by a public works project.

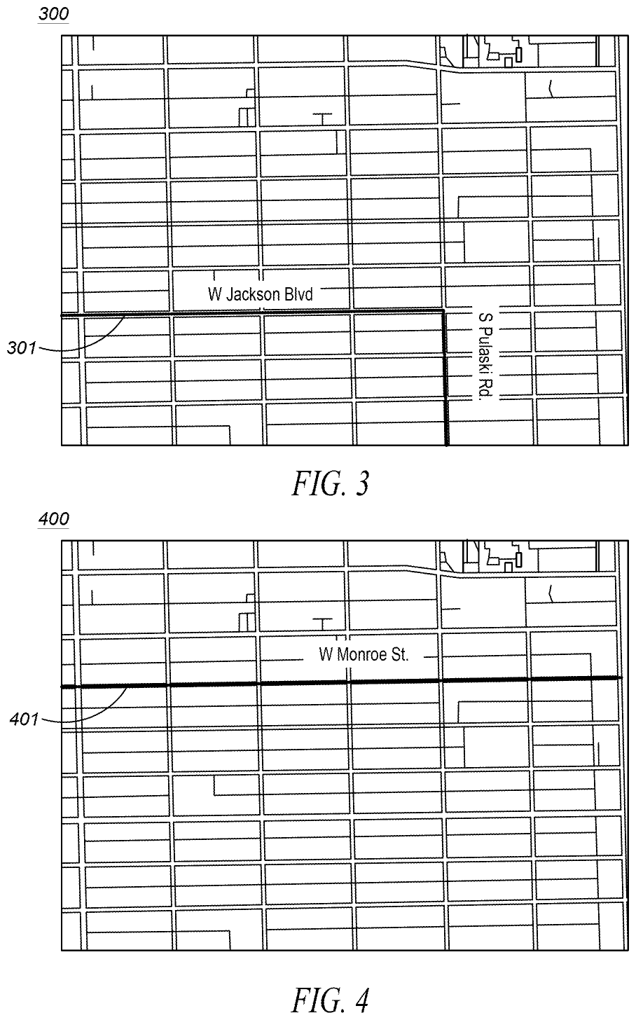

FIG. 3 is an illustration of heat map 300 showing locations 301 frequented by a first police officer. As is evident, the locations 301 frequented by the first police officer on heat map 300 comprises route most often traveled by the first police officer. In this particular example, route comprises a geographic area where the officer has been detected over a predetermined number of times per time period. For example, the area frequented by the first police officer shown in FIG. 3 may comprise those areas where the first police officer has been located over 50 times last month. As is evident, the first officer routinely travels on parts of W Jackson Blvd and S Pulaski Rd.

FIG. 4 is an illustration of heat map 400 showing locations 401 frequented by a second police officer. As is evident, the locations 401 frequented by the second police officer on heat map 400 comprises route most often traveled by the second police officer. In this particular example, route comprises a geographic area where the second officer has been detected over a predetermined number of times per time period. For example, the area frequented by the second police officer shown in FIG. 4 may comprise those areas where the second police officer has been located over 50 times last month. As is evident, the second officer routinely travels on parts of W Monroe St.

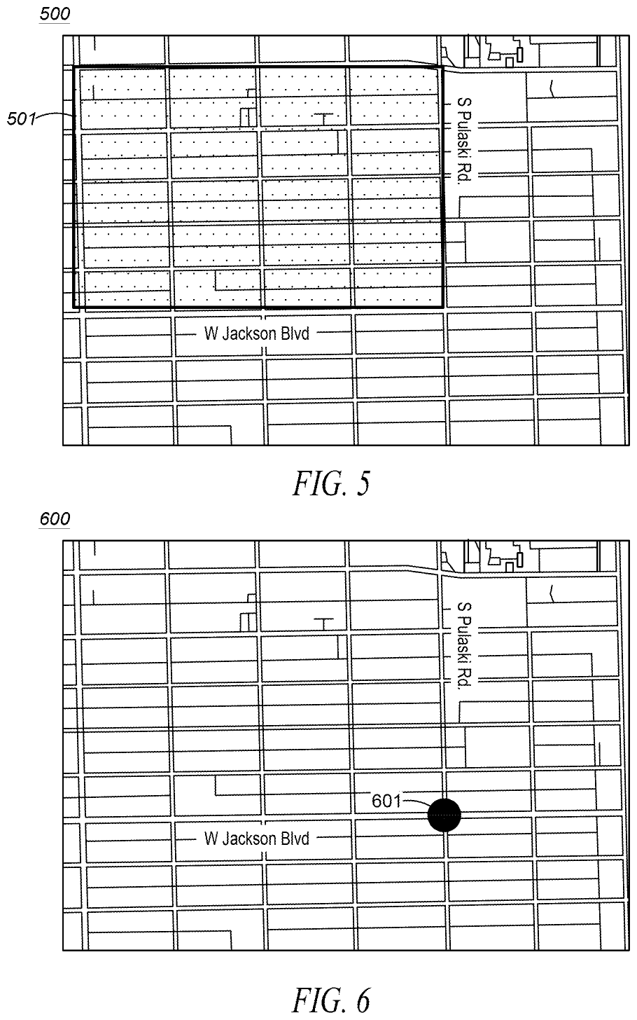

FIG. 5 is an illustration of beat map 500 showing locations 501 frequented by a third police officer. The locations 501 frequented by the third police officer on beat map 500 comprises beat assigned to the third police officer. In this particular example, beat comprises a geographic area where the third officer has been assigned to patrol. As is evident, the third officer's beat is bounded on the south and east by W Jackson Blvd and S Pulaski Rd.

FIG. 6 is an illustration of a map showing a location of a planned public works project.

During operation, logic circuitry 203 will access public works database 111 to determine that public works will be doing construction at the corner of W Jackson Blvd and S Pulaski Rd. Logic circuitry 203 will then determine areas affected by the construction (e.g., areas within 50 meters of the construction). As is evident, the first officer and the third officer will have areas they frequent affected by the construction (e.g., areas they frequent within a predetermined distance (e.g. 50 meters) from the areas affected by the construction). This will trigger logic circuitry 203 to send a notification of the potential disruption to their normally-traveled route. The second officer will not receive the notification. As discussed above, the notification will be sent electronically, and may comprise text identifying the location of the disruption (e.g., “NOTICE: Construction is planned at the corners of W Jackson Blvd and S Pulaski Rd., this may affect your usual routes).

In some circumstances it may be beneficial to dispatch additional public safety officers to an area where a public works project is located if the project is heavily affecting an area frequented by an officer. For example, if an officer has part of their beat affected by a public works project so that they have a difficult time patrolling their beat, additional resources may be needed to effectively patrol the beat that is affected by the public works project. With this in mind, server 101 may notify a public safety dispatch center that an area frequented by an officer will be affected by a public works project. This notification (which may be equivalent to the notification sent to the public safety officer) may be sent so that an operator at the public safety dispatch center can dispatch additional public safety officers to an area frequented by the public safety officer when the area is affected by at least one public works project.

The notification (similar to the notification sent to the public safety officer) is sent to the public safety dispatch center, and received by a public safety dispatch center operator. In one embodiment the notification is sent along with the notification that is sent to the public safety officer. In other words, the same criteria used to send the notification to the public safety officer is used to send the notification to the public safety dispatch center. However, in an alternate embodiment of the present invention, the notification is only sent to the public safety dispatch center when sensor information indicates that the area is heavily affected by the public works project. For example, when excessive traffic exists around the public works project, or when visual or infrared cameras indicate that gridlock is occurring in the area around the public works project, then the notification will be sent.

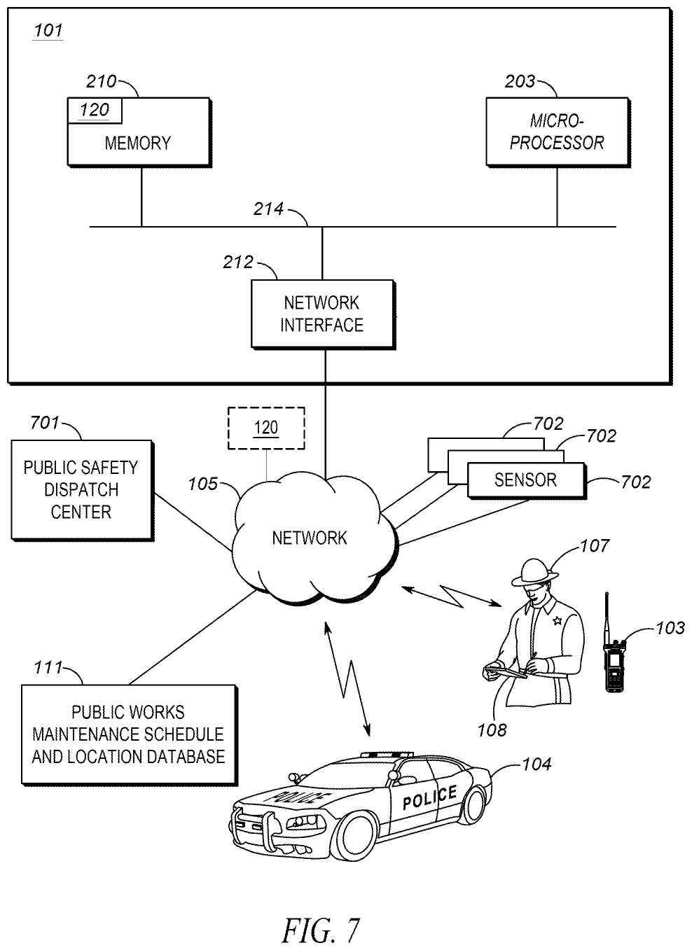

FIG. 7 illustrates a general operating environment with the addition of public safety dispatch center 701 and sensors 702. Sensors 702 preferably comprise sensors that can indicate an area is heavily affected by a public works project. Sensors such as seismic sensors, stress sensors, visual or infrared cameras, traffic sensors, and meteorological sensors (e.g., rainfall, wind, or snow sensors) are connected to network 105 and ultimately to server 101 through network interface 212.

As shown in FIG. 7, public safety dispatch center 701 is coupled to server 101 through network 105. Dispatch center 701 preferably comprises an office where employees manage a group of vehicles, especially for the emergency services, and send them where they are needed.

During operation, logic circuitry 203 may simply send a notification to dispatch center 701 when a notification to an officer is sent. However, in an alternate embodiment of the present invention, logic circuitry 203 may access sensors 702 to determine that an area frequented by a police officer is heavily affected by the public works project (e.g., heavy traffic exists in the area, the area is grid locked, the area is flooded, heavy snowfall is occurring, heavy rain is occurring, . . . , etc.). The notification may be sent only after it is determined that the area is heavily affected by the public works project.

With the above in mind, the server of FIG. 7 is configured to electronically transmit, via network interface 212, a request to dispatch additional public safety officers to an area frequented by the public safety officer when the area frequented by the public safety officer is nearby an area affected by at least one public works project. In this embodiment, network interface 212 receives sensor information from sensors located near an area affected by at least one public works project and logic circuitry 203 is additionally configured to determine, via the sensor information, if the area affected by at least one public works project is heavily affected, and if so, electronically transmit, via the network interface, a request to dispatch additional public safety officers to the area frequented by the public safety officer.

At least one public works project is heavily affected when the at least one public works project has a nearby road that has excessive traffic.

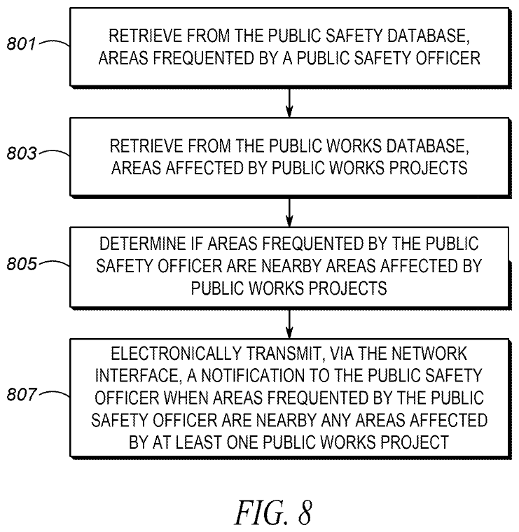

FIG. 8 is a flow chart showing operation of the server of FIG. 2. The logic flow begins at step 801 where logic circuitry 203 retrieves from the public safety database, areas frequented by a public safety officer. At step 803, logic circuitry 203 retrieves from the public works database, areas affected by public works projects. Logic circuitry 203 then determines if areas frequented by the public safety officer are nearby areas affected by public works projects (step 205) and electronically transmits, via the network interface, a notification to the public safety officer when areas frequented by the public safety officer are nearby any areas affected by at least one public works project, wherein the notification indicates locations of the public works projects that are nearby areas frequented by the public safety officer.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A server comprising:
a network interface coupled to a public works database and a public safety database;
logic circuitry coupled to the network interface, the logic circuitry configured to:
retrieve from the public safety database, areas frequented by a public safety officer;
retrieve from the public works database, locations of public works projects;
determine if areas frequented by the public safety officer are nearby areas affected by public works projects; and
electronically transmit, via the network interface, a notification to the public safety officer when areas frequented by the public safety officer are nearby any areas affected by at least one public works project, wherein the notification indicates locations of the public works projects that are nearby areas frequented by the public safety officer.

2. The server of claim 1 wherein the network interface comprises a cross-agency network interface, with the public safety database being maintained by a public safety agency, and the public works database being maintained by a public works agency.

3. The server of claim 1 wherein an area is affected by the public works project when the public works project is within a predetermined distance from the area.

4. The server of claim 1 wherein the logic circuitry is further configured to:
determine a plurality locations of the public safety officer over a period of time;
determine the areas most frequented by the public safety officer from the plurality locations of the public safety officer over the period of time; and
store the areas most frequented by the public safety officer in the public safety database.

5. The server of claim 4 wherein the areas most frequented by the public safety officer are stored in the public safety database as a heat map.

6. The server of claim 1 wherein the areas most frequented by the public safety officer comprise a beat map.

7. The server of claim 6 wherein the beat map is stored in the public safety database.

8. The server of claim 1 wherein the logic circuitry is additionally configured to:
electronically transmit, via the network interface, a request to dispatch additional public safety officers to an area frequented by the public safety officer when the area frequented by the public safety officer is nearby an area affected by at least one public works project.

9. The server of claim 1 wherein:
the network interface receives sensor information from sensors located near an area affected by at least one public works project; and
wherein the logic circuitry is additionally configured to:
determine, via the sensor information, if the area affected by at least one public works project is heavily affected, and if so, electronically transmit, via the network interface, a request to dispatch additional public safety officers to the area frequented by the public safety officer.

10. The server of claim 9 wherein at least one public works project is heavily affected when the at least one public works project has a nearby road that has excessive traffic.

11. The server of claim 9 wherein the sensors comprise sensors taken from the group consisting of seismic sensors, stress sensors, visual or infrared cameras, traffic sensors, rainfall sensors, wind sensors, and snow sensors.

12. A server comprising:
a network interface coupled to a public works database and a public safety database;
logic circuitry coupled to the network interface, the logic circuitry configured to:
retrieve from the public safety database, areas frequented by a first and a second public safety officer;
retrieve from the public works database, locations of public works projects;
determine that areas frequented by the first public safety officer are nearby areas affected by a public works project;
determine that areas frequented by the second public safety officer are not nearby areas affected by a public works project; and
only electronically transmitting, via the network interface, a notification to the first public safety officer based on the determination that areas frequented by the first public safety officer are nearby areas affected by a public works project, wherein the notification indicates locations of the public works projects that are nearby areas frequented by the first public safety officer.

13. The server of claim 12 wherein the network interface comprises a cross-agency network interface, with the public safety database being maintained by a public safety agency, and the public works database being maintained by a public works agency.

14. The server of claim 12 wherein an area is affected by the public works project when the public works project is within a predetermined distance from the area . . .

15. A method comprising the steps of:
retrieving from a public safety database, areas frequented by a public safety officer;
retrieving from a public works database, areas affected by public works projects;
determining if areas frequented by the public safety officer are nearby areas affected by public works projects; and
electronically transmitting, via a network interface, a notification to the public safety officer when areas frequented by the public safety officer are nearby any areas affected by at least one public works project, wherein the notification indicates locations of the public works projects that are nearby areas frequented by the public safety officer.
